(19) United States
(12) Patent Application Publication
(10) Pub. No.: US 2024/0425422 A1
(43) Pub. Date: Dec. 26, 2024

(54) METHOD OF FORMING A SMOOTH AS-FABRICATED CERAMIC MATRIX COMPOSITE (CMC) SURFACE

(71) Applicants: Rolls-Royce High Temperature Composites Inc., Cypress, CA (US); Rolls-Royce North American Technologies Inc., Indianapolis, IN (US)

(72) Inventors: Sujit Nanda, Cypress, CA (US); Jeremy Roehm, Indianapolis, IN (US)

(73) Assignees: Rolls-Royce High Temperature Composites Inc., Cypress, CA (US); Rolls-Royce North American Technologies Inc., Indianapolis, IN (US)

(21) Appl. No.: 18/213,561

(22) Filed: Jun. 23, 2023

(51) Int. Cl. C04B 35/80; C04B 35/565; C04B 41/00; C04B 41/91

(52) U.S. Cl. CPC C04B 35/80; C04B 35/565; C04B 41/0072; C04B 41/91; C04B 2235/3826; C04B 2235/428; C04B 2235/5256; C04B 2235/614; C04B 2235/616; C04B 2235/963

(57) ABSTRACT

A method of forming a ceramic matrix composite having a smooth surface includes laying up a plurality of plies, where some or all of the plies include an arrangement of spread tows comprising carbon fibers, thereby forming a fiber preform. Each spread tow has a height-to-width aspect ratio of less than about 0.1. The fiber preform is infiltrated with a ceramic matrix material and/or ceramic matrix precursor to embed the carbon fibers in a ceramic matrix. Thus, a ceramic matrix composite comprising a smooth and/or flat surface devoid of undulations from rounded tows is formed.

### TECHNICAL FIELD

The present disclosure relates generally to composite fabrication and more particularly to reinforcement of ceramic matrix composites with carbon fibers.

### BACKGROUND

Ceramic matrix composites, which include ceramic or carbon fibers embedded in a ceramic matrix, exhibit a combination of properties that make them promising candidates for industrial applications that demand excellent thermal and mechanical properties along with low weight. Fabrication of a ceramic matrix composite may include laying up a number of 2D woven fabric plies into a desired 3D geometry to form a fiber preform, where each ply includes an arrangement (e.g., a 2D weave) of fiber tows made up of bundles of ceramic or carbon fibers. The fiber preform may then be densified to embed the ceramic or carbon fibers in a ceramic matrix, thereby forming the ceramic matrix composite (CMC).

A challenge is obtaining flat and/or smooth composite surfaces due to undulations inherent to the bundles of fiber tows that make up the woven fabric plies. Certain CMC components, such as airframe structures and space vehicle reentry components, may benefit from improved surface smoothness for enhanced aerodynamic performance and profile tolerances.

### BRIEF DESCRIPTION OF THE DRAWINGS

The embodiments may be better understood with reference to the following drawing(s) and description. The components in the figures are not necessarily to scale. Moreover, in the figures, like-referenced numerals designate corresponding parts throughout the different views.

FIG. 1 is a flow chart showing exemplary steps in the method.

FIG. 2A shows a portion of a lay-up of plies include spread tows comprising carbon fibers.

FIG. 2B shows a portion of lay-up of plies including conventional rounded tows comprising carbon fibers.

### DETAILED DESCRIPTION

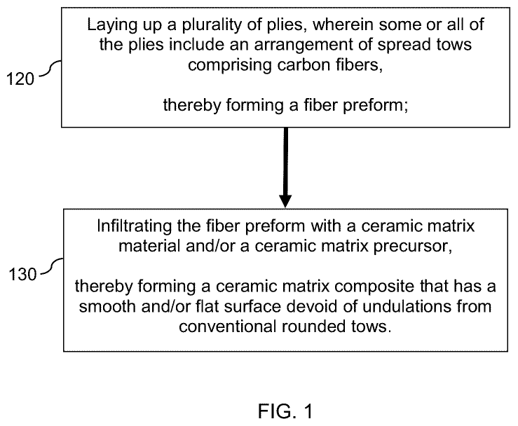

Referring to the flow chart of FIG. 1, the method of forming a ceramic matrix composite having a smooth surface may be carried out as described below.

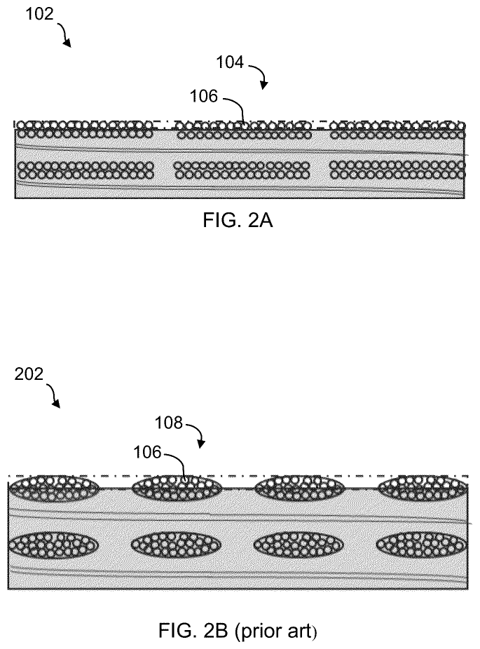

A plurality of plies may be laid up 120, where some or all of the plies being laid up include an arrangement (e.g., a 2D weave) of spread tows comprising carbon fibers. A spread tow 104 may take the form of a flattened bundle of carbon fibers 106, as illustrated in the exemplary lay-up 102 shown in FIG. 2A, in contrast to a conventional rounded tow 108 of carbon fibers 106, which has a circular or oval transverse cross-section, shown by the lay-up 202 of FIG. 2B. Accordingly, each spread tow 104 may have a transverse cross-sectional aspect ratio (height-to-width) that is much less than 1, such as less than 0.1. Upon lay-up of the plurality of plies 110, a fiber preform is formed. The preform may have a shape and size based on the component to be produced that is determined by the lay-up. In examples where only some of the plies being laid up include spread tows, it is understood that the fiber preform may be constructed from plies including spread tows as well as from plies including rounded tows. In other examples, where all of the plies being laid up include spread tows, it is understood that the fiber preform may be constructed entirely from spread tows and may not include any rounded tows.

The fiber preform is then infiltrated 130 with a ceramic matrix material and/or ceramic matrix precursor, as discussed in greater detail below, to embed the carbon fibers in a ceramic matrix and form a densified ceramic matrix composite having a smooth and/or flat surface. Infiltration 130 of the fiber preform to effect densification may comprise chemical vapor infiltration, slurry infiltration, and/or melt infiltration, as discussed below. Advantageously, the smooth and/or flat surface formed upon densification may be substantially or completely devoid of undulations from conventional rounded tows, allowing for improved aerodynamic performance from the ceramic matrix composite component. More specifically, the surface does not include macroscale bumps or undulations.

For optimal smoothness of the composite surface, the height-to-width aspect ratio of the spread tows may be no greater than about 0.1, no greater than about 0.01, and as small as about 0.001. The carbon fibers may be continuous carbon fibers having lengths much larger than their diameters. Typically, each carbon fiber has a diameter in a range from about 2 microns to about 12 microns, or from about 5 microns to about 8 microns. Instead of the oval or rounded cross-sectional shape of conventional fiber tows (FIG. 1B), the spread tows of this disclosure may have a generally rectangular cross-sectional shape, as illustrated in FIG. 1A. The generally rectangular cross-sectional shape may be defined by uniform layers of carbon fibers. For examples, each of the spread tows may include from 2 to 10 layers of carbon fibers, or from 2 to 5 layers of carbon fibers. It is pointed out that FIG. 1A is not to scale, as the carbon fibers may have a micron-scale diameter, while each tow may have a milliscale width (e.g., several to tens of millimeters). Each tow typically includes at least 1,000 carbon fibers, or at least 5,000 carbon fibers, and/or as many as 12,000 carbon fibers, or as many as 24,000 carbon fibers.

Spread tows may be produced by pulling carbon fibers over spreader bars while under high tension, impinging pressurized air on the carbon fibers, and/or exposing the carbon fibers to ultrasonic or sonic vibrations. Using one of these or another approach, the fiber tows may be spread into thin, wide tapes. For example, a 5-mm wide rounded tow may be spread to form a 25-mm wide tape having a sub-100 micron thickness. The resulting tapes may be 2D or 3D woven into thin fabrics that may be cut as needed to form the plies described above. Spread tow fabrics or plies may be obtained from commercial suppliers, such as TeXtreme®, Oxeon AB (Boras, Sweden). Typically, woven fabrics and/or tapes formed using the spread tows may have a thickness below 100 microns and as low as about 20 microns.

The method may further include, prior to lay-up of the spread-tow plies, heat treating the plies to stabilize the performance of the carbon fibers in service. Heat treating stabilizes the fiber volumetrically, resulting in a more robust ceramic matrix composite. During heat treatment, the carbon fibers undergo a slight increase in density as the diameter of the fiber shrinks slightly. If the fiber were not heat treated prior to application of the fiber interface coating and subsequent densification of the ceramic matrix, this shrinkage may occur in-service of the CMC component, leading to degradation of the bond with the fiber interface coating, and introducing pathways for accelerated environmental attack. The heat treatment may be carried out at a temperature in a range from about 1600° C. to about 2000° C., typically in a controlled environment (e.g., vacuum, inert gas, or nitrogen gas). In some examples, fabrics comprising the spread tows may be heat treated prior to cutting the fabrics into plies of the desired size and shape.

After laying up the plies to form the fiber preform, infiltration (e.g., chemical vapor infiltration, slurry infiltration, and/or melt infiltration) may be carried out to effect densification and embed the carbon fibers in a ceramic matrix, as indicated above. Each of the various infiltration processes is described below.

During chemical vapor infiltration (CVI), gaseous precursors are infiltrated into the fiber preform, normally while the fiber preform is in a controlled environment such as a vacuum chamber at an elevated temperature, such as in a range from 600° C. to 1500° C. The gaseous precursors diffuse through the fiber preform, and reaction products deposit on exposed surfaces of the carbon fibers, forming a coating of a desired composition that comprises the ceramic matrix material. For example, for a ceramic matrix material comprising silicon carbide, the gaseous precursors infiltrated into the fiber preform may comprise methyltrichlorosilane (CH₃SiCl₃) and hydrogen (H₂). During CVI, an interior of the vacuum chamber is typically maintained at a pressure below atmospheric pressure (760 Torr). In one example, the process chamber may be maintained at a pressure in a range from about 1 Torr to about 50 Torr during delivery of the gaseous precursors and deposition of the reaction products. Thus, prior to introducing the gaseous precursors, the vacuum chamber may be evacuated to a desired sub-atmospheric pressure level using one or more vacuum pumps. Typically, CVI is followed by slurry infiltration and melt infiltration, but it is possible to produce a densified ceramic matrix composite utilizing CVI alone.

During slurry infiltration, which may follow CVI, a slurry including particles comprising the ceramic matrix material is infiltrated into the fiber preform. The ceramic particles are dispersed in a liquid carrier, such as water or an organic solvent, which may be removed by drying after the slurry has infiltrated the fiber preform. In addition to the ceramic particles, the slurry may optionally include reactive elements, such as carbon particles, and/or small amounts of other additives, such as surfactant(s) and/or dispersant(s) known in the art to inhibit agglomeration of the particles. In one example, the slurry is an aqueous slurry including silicon carbide particles dispersed in water. Alternatively, the slurry may include a ceramic matrix precursor comprising a preceramic polymer. In such an example, during slurry infiltration, the preceramic polymer may be infiltrated into the fiber preform, and, after slurry infiltration, the preceramic polymer may be converted to the ceramic matrix material by pyrolysis.

Slurry infiltration may be carried out utilizing a pressure differential. For example, the fiber preform may be immersed in the slurry while under vacuum (that is, while exposed to a sub-atmospheric pressure), and then, while the fiber preform remains immersed in the slurry, the pressure may be increased. The pressure differential (more specifically, the pressure increase) may force the slurry into the interstices of the fiber preform, ensuring more complete infiltration. For example, if the fiber preform is immersed in the liquid in a vacuum chamber maintained at a sub-atmospheric pressure, such as 1×10⁻² Torr or lower, the pressure may be increased by breaking (releasing) the vacuum (e.g., by opening a valve), such that the pressure in the vacuum chamber equilibrates with the surrounding (ambient) environment. The process of releasing the vacuum such that the pressure in the vacuum chamber increases may be referred to as backfilling. Ambient air may be employed for backfilling, or a non-reactive gas such as argon, helium, or nitrogen may be utilized. After slurry infiltration and drying to remove the liquid carrier, an impregnated fiber preform or green body, i.e., a fiber preform loaded with particulate matter, is formed, typically having a porosity in a range from about 15 vol. % to about 25 vol. %.

During melt infiltration, which may follow CVI and/or slurry infiltration, a molten material comprising silicon may be infiltrated into the fiber preform. As the molten material flows through the fiber preform, it undergoes reactions and/or solidification to form a ceramic matrix comprising silicon carbide. The molten material may consist essentially of silicon (e.g., elemental silicon and any incidental impurities) or may comprise a silicon-rich alloy. Melt infiltration may be carried out at a temperature at or above the melting temperature of silicon or the silicon-rich alloy which is infiltrated. Thus, the temperature for melt infiltration is typically in a range from about 1400° C. to about 1500° C. A suitable time duration for melt infiltration may be from 15 minutes to four hours, depending in part on the size and complexity of the ceramic matrix composite component to be formed.

The carbon-fiber reinforced ceramic matrix composite formed as described in this disclosure may form part or all of a component that has stringent aerodynamic requirements, such as airframe structures (e.g., ducts, bodies, wings, leading edges, control surfaces), space vehicle reentry structures, and/or hypersonic structures. As indicated above, the surface of the ceramic matrix composite is devoid or substantially devoid of macroscale bumps or undulations, that is bumps or undulations having a height above about 100 microns, above about 75 microns, or above about 50 microns.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a method of forming a ceramic matrix composite having a smooth and/or flat surface, the method comprising: laying up a plurality of plies, some or all of the plies including an arrangement of spread tows comprising carbon fibers, each spread tow having a height-to-width aspect ratio of less than about 0.1, thereby forming a fiber preform; and infiltrating the fiber preform with a ceramic matrix material and/or ceramic matrix precursor to embed the carbon fibers in a ceramic matrix, thereby forming a ceramic matrix composite comprising a smooth and/or flat surface devoid of undulations from rounded tows.

A second aspect relates to the method of the preceding aspect, wherein the aspect ratio is in a range from about 0.001 to about 0.01.

A third aspect relates to the method of any preceding aspect, wherein each of the spread tows comprises a generally rectangular cross-section.

A fourth aspect relates to the method of any preceding aspect, wherein the arrangement of spread tows comprises a 2D weave of the spread tows.

A fifth aspect relates to the method of any preceding aspect, wherein infiltrating the fiber preform comprises chemical vapor infiltration, slurry infiltration, and/or melt infiltration.

A sixth aspect relates to the method of any preceding aspect, wherein infiltrating the fiber preform comprises chemical vapor infiltration, and wherein, during chemical vapor infiltration, a coating comprising the ceramic matrix material is deposited on the fiber preform.

A seventh aspect relates to the method of any preceding aspect, wherein infiltrating the fiber preform comprises slurry infiltration, and wherein, during slurry infiltration, particles comprising the ceramic matrix material are embedded in the fiber preform.

An eighth aspect relates to the method of any preceding aspect, wherein infiltrating the fiber preform comprises slurry infiltration, wherein the ceramic matrix precursor comprises a preceramic polymer, wherein, during slurry infiltration, the preceramic polymer is infiltrated into the fiber preform, and wherein, after slurry infiltration, the preceramic polymer is converted to the ceramic matrix material by pyrolysis.

A ninth aspect relates to the method of the preceding aspect, wherein the ceramic matrix material comprises silicon carbide.

A tenth aspect relates to the method of the preceding aspect, wherein infiltrating the fiber preform comprises melt infiltration, wherein the ceramic matrix precursor comprises a molten material comprising silicon, and wherein, during melt infiltration, the molten material flows through the fiber preform and undergoes reactions and/or solidification to form a ceramic matrix comprising silicon carbide.

An eleventh aspect relates to the method of any preceding aspect, wherein the each of the spread tows includes from 2 to 10 layers of carbon fibers.

A twelfth aspect relates to the method of any preceding aspect, wherein each of the plies has a thickness in a range from about 20 microns to about 100 microns.

A thirteenth aspect relates to the method of the preceding aspect, wherein the smooth and/or flat surface does not include bumps or undulations having a height above about 100 microns.

A fourteenth aspect relates to the method of any preceding aspect, wherein only some of the plurality of plies being laid up include the arrangement of spread tows, the spread tows being present only within a surface region of the ceramic matrix composite.

A fifteenth aspect relates to the method of any preceding aspect, wherein all of the plurality of plies being laid up include the arrangement of spread tows, the spread tows being present through an entire thickness of the ceramic matrix composite.

A sixteenth aspect relates to the method of any preceding aspect, further comprising, prior to laying up the plurality of plies: heat treating the plurality of plies.

A seventeenth aspect relates to the method of any preceding aspect, further comprising, prior to laying up the plurality of plies: heat treating fabrics comprising the spread tows; and after the heat treating, cutting the fabrics to form the plurality of plies.

An eighteenth aspect relates to the method of the preceding aspect, wherein the heat treating comprises exposing the plies or the fabrics to a temperature of at least about 1600° C.

A nineteenth aspect relates to a ceramic matrix composite comprising: a ceramic matrix comprising silicon carbide; spread tows comprising carbon fibers embedded in the ceramic matrix; and a smooth and/or flat surface devoid of undulations from rounded tows.

A twentieth aspect relates to the ceramic matrix composite of the preceding aspect, wherein the smooth and/or flat surface does not include bumps or undulations having a width or height in a range from 1 micron to 10 microns and/or in a range from 0.1 micron to less than 1 micron.

In addition to the features mentioned in each of the independent aspects enumerated above, some examples may show, alone or in combination, the optional features mentioned in the dependent aspects and/or as disclosed in the description above and shown in the figures.

What is claimed is:

1. A method of forming a ceramic matrix composite having a smooth and/or flat surface, the method comprising:
laying up a plurality of plies, some or all of the plies including an arrangement of spread tows comprising carbon fibers, each spread tow having a height-to-width aspect ratio of less than about 0.1, thereby forming a fiber preform; and
infiltrating the fiber preform with a ceramic matrix material and/or ceramic matrix precursor to embed the carbon fibers in a ceramic matrix, thereby forming a ceramic matrix composite comprising a smooth and/or flat surface devoid of undulations from rounded tows.

2. The method of claim 1, wherein the aspect ratio is in a range from about 0.001 to about 0.01.

3. The method of claim 1, wherein each of the spread tows comprises a generally rectangular cross-section.

4. The method of claim 1, wherein the arrangement of spread tows comprises a 2D weave of the spread tows.

5. The method of claim 1, wherein infiltrating the fiber preform comprises chemical vapor infiltration, slurry infiltration, and/or melt infiltration.

6. The method of claim 1, wherein infiltrating the fiber preform comprises chemical vapor infiltration, and
wherein, during chemical vapor infiltration, a coating comprising the ceramic matrix material is deposited on the fiber preform.

7. The method of claim 1, wherein infiltrating the fiber preform comprises slurry infiltration, and
wherein, during slurry infiltration, particles comprising the ceramic matrix material are embedded in the fiber preform.

8. The method of claim 1, wherein infiltrating the fiber preform comprises slurry infiltration,
wherein the ceramic matrix precursor comprises a preceramic polymer,
wherein, during slurry infiltration, the preceramic polymer is infiltrated into the fiber preform, and
wherein, after slurry infiltration, the preceramic polymer is converted to the ceramic matrix material by pyrolysis.

9. The method of claim 1, wherein the ceramic matrix material comprises silicon carbide.

10. The method of claim 1, wherein infiltrating the fiber preform comprises melt infiltration,
wherein the ceramic matrix precursor comprises a molten material comprising silicon, and
wherein, during melt infiltration, the molten material flows through the fiber preform and undergoes reactions and/or solidification to form a ceramic matrix comprising silicon carbide.

11. The method of claim 1, wherein the each of the spread tows includes from 2 to 10 layers of carbon fibers.

12. The method of claim 1, wherein each of the plies has a thickness in a range from about 20 microns to about 100 microns.

13. The method of claim 1, wherein the smooth and/or flat surface does not include bumps or undulations having height above about 100 microns.

14. The method of claim 1, wherein only some of the plurality of plies being laid up include the arrangement of spread tows, the spread tows being present only within a surface region of the ceramic matrix composite.

15. The method of claim 1, wherein all of the plurality of plies being laid up include the arrangement of spread tows, the spread tows being present through an entire thickness of the ceramic matrix composite.

16. The method of claim 1, further comprising, prior to laying up the plurality of plies:
heat treating the plurality of plies.

17. The method of claim 1, further comprising, prior to laying up the plurality of plies:
heat treating fabrics comprising the spread tows; and
after the heat treating, cutting the fabrics to form the plurality of plies.

18. The method of claim 17, wherein the heat treating comprises exposing the plies or the fabrics to a temperature of at least about 1600° C.

19. A ceramic matrix composite comprising:
a ceramic matrix comprising silicon carbide;
spread tows comprising carbon fibers embedded in the ceramic matrix; and
a smooth and/or flat surface devoid of undulations from rounded tows.

20. The ceramic matrix composite of claim 19, wherein the smooth and/or flat surface does not include bumps or undulations having a width or height in a range from 1 micron to 10 microns and/or in a range from 0.1 micron to less than 1 micron.
